(19) United States
(12) Patent Application Publication
(10) Pub. No.: US 2013/0013399 A1
(43) Pub. Date: Jan. 10, 2013

(54) METHODS AND SYSTEMS FOR ADVERTISEMENT SELECTION DETECTION AND DELAYED PRESENTATION

(75) Inventor: Lawrence S. Rogel, Brookline, MA (US)

(73) Assignee: REDIGI INC., Cambridge, MA (US)

(21) Appl. No.: 13/365,777

(22) Filed: Feb. 3, 2012

Related U.S. Application Data
(60) Provisional application No. 61/439,194, filed on Feb. 3, 2011.

(51) Int. Cl. G06Q 30/02

(52) U.S. Cl. 705/14.49

(57) ABSTRACT

The invention provides in some aspects a system including a server digital data processor that executes on an ad server which is in communications coupling with a client digital data processor. An app executing on the client responds to display of an advertisement, effected by the ad server, by determining whether a user of the app has touched the screen (or otherwise responded to) a “get more information,” or other control displayed with the ad. If so, the app delays display of a web site or other collateral until the app reaches a suitable stopping point. At that point, the app queries the user to determine when and/or how he/she wishes to visit the web site and/or to have the collateral delivered.

This claims the benefit of filing of U.S. Patent Application Ser. No. 61/439,194, filed Feb. 3, 2011, the teachings of which are incorporated herein by reference.

### BACKGROUND OF THE INVENTION

The invention pertains to digital data processing and more particularly, by way of non-limiting example, to methods and systems for the detection of advertisements selected by a user during operation of a digital data processing system. The invention has application, by way of non-limiting example, in beneficial presentation of web sites and other marketing collateral selected by a user during presentation of an ad during operation of a game or other app(lication), e.g., on an iPhone, iPad or other mobile device.

Software creators, publishers, and distributors are ever looking for ways to increase their revenues. A popular target in this endeavor is advertising. Take, for example, Apple Inc. As exemplified by it's recent rollout of the iAd platform, that company intends to place advertisements (for itself and others) in third-party apps developed for the iPod, iPhone, iPad and other IOS devices. Developers and Apple, alike, will share in revenue for “clicks” on those ads by users who run those apps.

Apple is not the first to monetize ad click-throughs, of course. Google became a verb by doing the same thing on the web. Its success in that venue has been followed by DoubleClick, Inc., 24/7 Media, among others.

While a boon to marketers, click-through advertising is not universally welcomed by users. One aim of this invention is to change that.

A related aim is to provide improved methods and systems of digital data processing.

A further related aim is to provide such methods and systems as support the beneficial presentation of web sites and other marketing collateral selected by a user during presentation of an ad during operation of a game or other app(lication), e.g., on an iPhone or other mobile device.

### SUMMARY OF THE INVENTION

The foregoing are among the objects attained by the invention, which provides in some aspects a digital data processing system including a server digital data processor that executes an ad server which is in communications coupling with a client digital data processor, e.g., over the Internet or other network. An app executing on the client digital data processor responds to display of an advertisement, effected on that client device by the ad server, by determining whether a user of the app has touched the screen (or otherwise responded to) a “get more information,” “visit web site,” or other control displayed in connection with the ad. If so, the app delays display of a web site or other collateral associated with the ad, e.g., until until the app reaches a suitable stopping point, e.g., completion of a current round in a game app, the current exam in an educational app, and so forth. The app then queries the user to determine when and/or how he/she wishes to visit the web site and/or to have the collateral delivered, immediately visiting and/or effecting collateral deliver, or scheduling same, in accord with the user's wishes.

In further related aspects of the invention, the app is any of an educational, entertainment, productivity, utility, navigation, or social networking application.

Still other aspects of the invention provide methods of digital data processing paralleling the operations described above.

These and other aspects of the invention are evident in the drawings and in the description that follows.

### BRIEF DESCRIPTION OF THE DRAWINGS

A more complete understanding of the invention may be attained by reference to the drawings, in which:

FIG. 1 depicts a digital data processing system in which the invention can be practiced; and

FIG. 2 depicts a methodology according to the invention for use with the system of FIG. 1.

### DETAILED DESCRIPTION

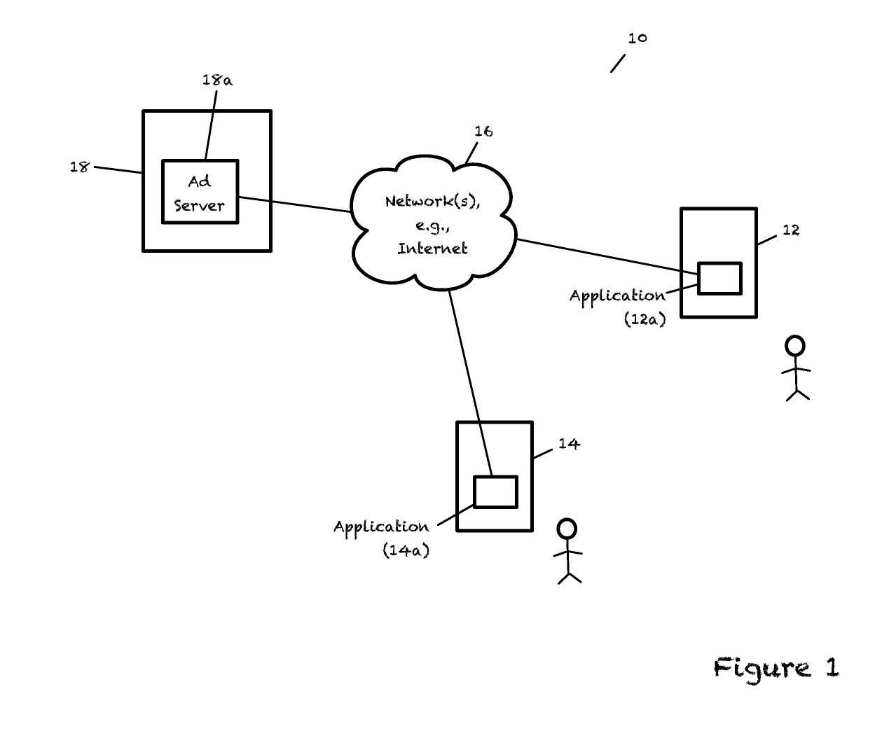

FIG. 1 depicts a digital data processing system 10 of the type in which the invention may be practiced. This includes a server digital data processor 18 that is coupled to client digital data processors 12, 14 via the Internet, a wide area network (WAN), metropolitan area network (MAN), local area network (LAN), telephone networks and/or a combination of these and other networks (wired, wireless, public, private or otherwise)—all indicated here by the network element 16.

The illustrated client digital data processors 12, 14 are conventional desktop computers, workstations, minicomputers, laptop computers, tablet computers, PDAs or other digital data processing apparatus of the type that are commercially available in the marketplace and that are suitable for operation in the illustrated system as described herein, all as adapted in accord with the teachings hereof. Here, those digital data processors are of the type and configuration used in a consumer (or home) environment; however, the invention may be practiced in any variety of other computing environments, networked or otherwise.

The digital data processors 12, 14 comprise central processing, memory, storage and input/output units and other constituent components (not shown) of the type conventional in the art that are configured to form applications 12a, 14a respectively, which in the illustrated embodiment comprise educational, entertainment, productivity, utility, navigation, social networking or other apps (applications) of the type commercially available in the market-place and/or otherwise suitable for operation on devices 12, 14, as adapted in accord with the teachings hereof.

Though, illustrated apps are of the stand-alone variety, they may instead (or in addition) comprise web applications suitable for execution within a browser or otherwise. Indeed, in some embodiments, one or more of apps 12a, 14a comprise individual web pages (or portions thereof, e.g., frames within web page).

The central processing, memory, storage and input/output units of client digital data processors 12, 14 may be configured to form and/or may be supplemented by other elements of the type known in the art desirable or necessary to support applications 12a, 14a, respectively, in accord with the teachings hereof, as well as to support other operations of the digital data processor 12, 14. These can include, by way of non-limiting example, peripheral devices (such as keyboards and monitors), operating systems, database management systems, and network interface cards and software, e.g., for supporting communications with server digital data processor 18 and other devices over network 16.

Although digital data processors 12, 14 are depicted and described in like manner here, it will be appreciated that this is for sake of generality and convenience: in other embodiments, these devices may differ in architecture and operation from that shown and described here and/or from each other, all consistent with the teachings hereof. Moreover, it will be appreciated that although only two closely positioned client devices 12, 14 are shown, other embodiments may have greater or fewer numbers of these devices disposed near and/or far from one another, collocated behind one or more common firewalls or otherwise.

Like client digital data processors 12, 14, the server digital data processor 18 is a digital data processing apparatus of the type commercially available in the marketplace suitable for operation in the illustrated system as described herein, as adapted in accord with the teachings hereof. Though the server 18 is typically implemented in a server-class computer, such as a minicomputer, it may also be implemented in a desktop computer, workstation, laptop computer, tablet computer, PDA or other suitable apparatus (again, as adapted in accord with the teachings hereof).

Server digital data processor 18, too, comprises central processing, memory, storage and input/output units and other constituent components (not shown) of the type conventional in the art that are configured in accord with the teachings hereof to form an advertisement server 18a. As used herein, this refers to functionality that delivers advertisements or other marketing content to one or more of devices 12, 14 in a conventional manner known in the art, as adapted in accord with the teachings hereof. This can be at the request of apps 12a, 14a, at the behest of the server operator and/or advertisers (or their marketing agents) and/or media buying/distributing intermediaries, or otherwise, again, in a conventional manner known in the art, as adapted in accord with the teachings hereof. And, this can be at random and/or predefined intervals or otherwise, again, in a conventional manner known in the art, as adapted in accord with the teachings hereof.

In typical embodiments, the ad server 18a delivers advertisements to the client devices 12, 14 during operation of the respective apps 12a, 14a, e.g., in relation to a context in which those are being used by their respective users. For example, when an app is displaying images of a desert, the ad server 18a may deliver to that app an advertisement for a beverage; if an app is playing song, the server can deliver an advertisement for similar songs; and so forth.

Although only a single server digital data processor 18 is depicted and described here, it will be appreciated that other embodiments may have greater or fewer numbers of these devices disposed near and/or far from one another, collocated behind one or more common firewalls or otherwise. Those other servers may differ in architecture and operation from that shown and described here and/or from each other, all consistent with the teachings hereof. Still further, although server 18 of the illustrated embodiment is depicted as being remotely disposed from the client digital data processors 12, 14, in other embodiments, one or more of the client devices may be disposed in vicinity of the server and, indeed, may be co-housed with it.

In fact, in some embodiments, the ‘ad server’ is a software module that executes within the client digital data processor 12, 14 and that delivers ads only to apps running on that respective device 12, 14. Further indeed, in some embodiments, the ad server is a module or functionality that executes within a given app 12a, 14a and that delivers ads only to and via that app.

As noted above, ad server 18 delivers ad content to apps 12a, 14a, periodically or otherwise, at the request of the advertiser or otherwise, and/or in connection with a context in which the app is being used, or otherwise, all in the conventional manner known in the art as adapted in accord with the teachings hereof.

Likewise, applications 12a, 14a operate in the conventional manner known in the art vis-a-vis the educational, entertainment, productivity, utility, navigation, social networking or other functions that they normally perform on behalf of the users, their respective devices 12, 14 or otherwise, again, as adapted in accord with the teachings hereof.

Thus, for example, the apps 12a, 14a are adapted for the beneficial presentation of web sites and/or other marketing collateral selected by a user during display of ads by those respective apps. More particularly, for example, those apps are adapted to delay presentation of those web sites and/or other collateral until after the user has reached a suitable stopping point in the respective app. In the illustrated embodiment, that stopping point is termination (or near termination) of the app; in other embodiments, it may be completion of a current phase of the app (e.g., the current round in a game app, the current exam in an educational app, the current song in a music app, and so forth).

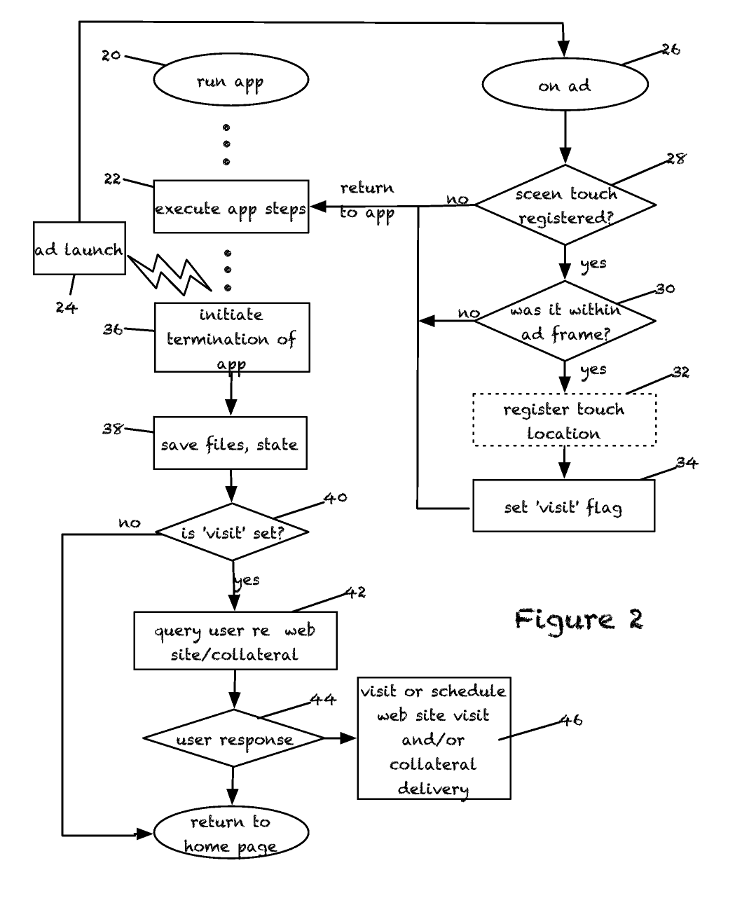

This is achieved in the illustrated embodiment utilizing a methodology as shown by way of non-limiting example in FIG. 2 with respect to app 12a. Illustrated app 14a can operate utilizing a similar methodology in order to achieve beneficial presentation of web sites and/or other marketing collateral selected by a user during display of ads by that respective app.

In illustrated steps 20, 22 the app 12a begins operation and runs, executing steps in the conventional manner of an app of its respective genre and, moreover, one suitable for presentation of (and/or for co-operation with) ads, e.g., served by ad server 18a.

In step 24, the app 12a displays an ad or other marketing content delivered by the server 18a. As noted above, this can be at the request of app 12a, at the behest of the server operator or otherwise, and can be at random and/or predefined intervals or otherwise. In the illustrated embodiment, this is accomplished in the conventional manner known in the art. And, though the illustrated embodiment involves ads served by server 18a, in other embodiments such ads may be delivered by the app 12a and or other functionality executing on the device 12, on one of its peers or otherwise. Moreover, though we speak here of display of the served ads by the app 12a, such ads may be displayed by other functionality of the device 12 in cooperation with the app 12a.

In step 26, the app begins execution of a sequence of one or more steps to register user response to display of the ad and, particularly, to determine if the user taps the screen, e.g., in response to a “get more information,” “visit web site,” or other such control displayed in connection with the ad and, particularly, in the illustrated embodiment, displayed within a view frame allocated to the ad and/or otherwise used by it during its display.

The sequence can be initiated in a variety of ways, e.g., upon “out of band” signaling from the server 18a to the app 12a that the ad has commenced. In the illustrated embodiment, however, commencement is detected by an event associated with start of the ad—e.g., by detection of a resizing of the view frame allocated by the operating system of device 12 to app 12a. And, though, in the discussion that follows, the steps of the sequence are treated as if executed during display of the ad, one or more of those steps may be executed after such display, as well and/or instead.

As those skilled in the art will appreciate, such resizing occurs, by way of non-limiting example, in the IOS operating system (e.g., that runs on iPhones and iPads) when the Apple Inc. ad server injects an ad into an executing app. Though the ad server doesn't directly signal the app 12a of ad commencement, that event can be inferred by app by detection of resizing. Though, in other embodiments, commencement of the ad can be detected in other manners.

In steps 28-30 the app detects a screen touch during execution of the ad and, particularly, a screen touch that occurs within the view frame allocated to the ad and/or outside that allocated to the app 12a. Such a touch is taken in the illustrated embodiment as indicative of user selection of a “get more information,” “visit web site,” or other such control displayed in connection with the ad.

If such a touch is detected, the app registers the event by setting a flag (here, referred to as “visit”) and, if possible, registers the location of the touch. This can be helpful in discerning user intent, e.g., by discerning whether the user indeed touched a control displayed with the ad and, if so, which one (if, indeed, multiple controls are displayed with the ad).

Following execution of steps within the sequence 26-34, control returns to the app which can respond to detection of a touch during the ad (e.g., as indicated by setting of the aforementioned flag) by immediately transferring control to a web browser and/or otherwise causing to be displayed a web site and/or other collateral associated with the ad—but which, preferably, defers such transfer and/or display until a suitable stopping point, e.g., termination of the app.

To that end, when the app reaches that point (indicated here as step 36), it saves files and/or state and/or takes such actions as otherwise customary at that point in the app's execution. See step 38.

If the visit flag is set (step 40), the app optionally queries the user on whether he/she wishes to visit the web site and/or view the marketing collateral implicated by the ad and, if so, how and/or when the user wishes to do so. See step 42. This can include querying the user about whether he/she wishes to visit the site via a browser, to have the collateral delivered via email, direct download, or otherwise, to visit the site and/or have the collateral delivered immediately and/or at another time (e.g., based on clock time and/or calendar date, on the type of connectivity and/or speed thereof between device 12 and network 21 and/or server 18), all by way of non-limiting example. Thus, by way of non-limiting example, the app can query the user and/or the user can otherwise specify that he or she wishes to visit the web site immediately, yet, have collateral delivered by e-mail when the user is in a “wifi” zone or otherwise has a high-speed and/or low-cost connection to the network and/or server.

Depending on the users responses to such querying, the app immediately transfers control to a browser or other functionality to view that site and/or submits such requests as are necessary (e.g., via web browser, e-mail or otherwise in order to display the collateral. See steps 44-46. If the user indicates that he/she wishes to effect the visit and/or delivery until later, the app takes such actions as are necessary and/or permissible on the device (e.g., scheduling a web browser and/or e-mail launch from the calendar, from a cron daemon, or otherwise). Presuming control is not immediately transferred to the web browser or other functionality in these steps, the app terminates and returns control to the OS, e.g., by placing the user back at the home screen.

Described above are systems and method meeting the desired objects, among others. It will be appreciated that the embodiments illustrated and described herein are merely examples of the invention and that other embodiments, incorporating changes thereto, fall within the scope of the invention.

Thus, by way of example, whereas the apps of the illustrated embodiment respond to ads displayed on the respective client devices by determining whether and where the respective user taps the screen, e.g., in response to controls displayed in connection with those ads, the apps of other embodiments may respond to keyboard touches or other user input for such purposes.

And, by way of further example, in other embodiments, functionality other than the app executing on the client device may perform such user input detection (e.g., whether on the screen or otherwise). Indeed, in some embodiments, the ad server may provide such detection and may signal the app of the user's actions, e.g., so that it (the app) may effect display of the web site or other marketing collateral at termination or otherwise.

And, by way of still further example, in other embodiments, steps 40-46 can be executed in addition to and/or in lieu of step 34 at the time a touch is registered.

In view of the foregoing,

What is claimed is:

1. A digital data processing system comprising:
A. a client digital data processor and an app executing thereon,
B. a server digital data processor and an ad server executing thereon, the ad server effecting display of an ad on the client digital data processor,
C. the app responding to display of an advertisement, effected on the client digital data processor by ad server, by determining whether a user of the app has responded to a control displayed in connection with the ad and, if so, querying the user regarding presentation of a web site or other collateral associated with the ad until the app reaches a stopping point.

2. The digital data processing system of claim 1, wherein the app responds determination that a user of the app has responded to a control displayed in connection with the ad by delaying presentation of a web site or other collateral associated with the ad until the app terminates.

3. The digital data processing system of claim 1, wherein the app responds determination that a user of the app has responded to a control displayed in connection with the ad by delaying presentation of a web site or other collateral associated with the ad until completion of a current phase of the app.

4. The digital data processor of claim 1, where the app detects when an ad is playing on the client digital data processor based on an event associated with start of the ad.

5. The digital data processor of claim 4 wherein the app detects when the ad starts based on resizing of view frame allocated by the client digital data processor to the app.

6. The digital data processor of claim 1, wherein the app is any of an educational, entertainment, productivity, utility, navigation, or social networking application.

7. A method of digital data processing comprising:
A. executing an app on a client digital data processor,
B. executing an ad server on a server digital data processor that is in communications coupling with the client digital data processor,
C. with the ad server, effecting display of an ad on the client digital data processor,
D. with the app, responding to display of the ad on the client digital data processor by determining whether a user of the app has responded to a control displayed in connection,
E. responding to an affirmative determination in step (D) by delaying presentation of a web site or other collateral associated with the ad until the app reaches a stopping point.

8. The method of claim 7, comprising responding to a determination that the user of the app has responded to a control displayed in connection with the ad by delaying presentation of a web site or other collateral associated with the ad until the app terminates.

9. The method of claim 7, comprising detecting when an ad is playing on the client digital data processor based on an event associated with start of the ad.

10. The method of claim 9, wherein the event is a resizing of a view frame allocated by the client digital data processor to the app.
